(19) United States
(12) Patent Application Publication
(10) Pub. No.: US 2008/0263006 A1
(43) Pub. Date: Oct. 23, 2008

(54) CONCURRENT SEARCHING OF STRUCTURED AND UNSTRUCTURED DATA

(75) Inventors: Andreas Wolber, Heidelberg (DE); Johannes Bechtold, Tairnbach (DE); Oliver Vossen, Walldorf (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/738,278

(22) Filed: Apr. 20, 2007

(51) Int. Cl. G06F 17/30

(52) U.S. Cl. 707/3

(57) ABSTRACT

The present disclosure relates to methods, systems, and software for querying heterogeneous business data comprising structured data and unstructured data. The structured data and unstructured data may be stored across one or more repositories. The combined query may be initiated when the system receives a query for the heterogeneous business data and automatically parses the received query into sub-queries. Each sub-query can be associated with either structured or unstructured data stored in one of the repositories. At least one of the sub-queries can include of a portion of the received query. The results of the various sub-queries can be merged automatically using business logic.

### TECHNICAL FIELD

This invention relates to data processing and, more particularly, to systems and software implementing a search that concurrently searches heterogeneous data comprising structured and unstructured data.

### BACKGROUND

Advances in electronic storage technology have made feasible the storage of vast amounts of this information as ever-larger storage capacity devices are introduced. In particular, as electronic storage densities increase and the cost of electronic storage decreases, businesses are eagerly adopting comprehensive electronic storage procedures for storing their business information. Additionally, the proliferation and widespread acceptance of electronic business transactions and communications has fueled significant demand for voluminous electronic storage capacity. Typically, businesses will store electronic information in storage devices, often referred to as data repositories or data stores. Databases of electronic information may be maintained in the data repositories, and the information may be organized as a series of objects, each object including one or more attributes that may take values.

Specifically, many computer systems include repositories or other storage facilities for holding structured data (such as database records or business objects) and unstructured data (such as files, attachments, and such). The systems typically provide some search functionality for a user to identify the particular item that the user is interested in. For example, a customer relationship management (CRM) solution may offer many different types of business objects to a system user (e.g., account data, running marketing plans, and so forth). There may be many object instances stored in the repository for each object type. Indeed, some systems include items of several different types, where each item type is managed by a separate application program. Moreover, different repositories or storage devices may be used to store unstructured data.

### SUMMARY

The present disclosure relates to methods, systems, and software for querying heterogeneous business data comprising structured data and unstructured data. In one general aspect, structured data may include business objects stored in structured repositories. Each repository may store several business objects, each business object associated with one or more nodes. Unstructured data can include attachments, each of which can be associated with a business object node. The results from an unstructured repository can be used to identify further results in a structured repository. The structured data and unstructured data may be stored across one or more repositories.

For example, a computer implemented method receives a query for the heterogeneous business data and automatically parses the received query into sub-queries. Each sub-query can be associated with either structured or unstructured data stored in one of the repositories. At least one of the sub-queries can include a portion of the received query. The results of the various sub-queries can be merged automatically using business logic. In some cases, unstructured repositories can be searched based on a textual search of the unstructured data, or unstructured repositories can also be searched based on an attribute search of the unstructured data. Results from structured and unstructured repositories can be automatically merged utilizing union and intersection operations.

Moreover, some or all of these aspects may be further included in respective systems or other devices for executing, implementing, or otherwise supporting concurrent searches of structured and unstructured data. For example, software operable to search structured and unstructured repositories can include a query splitter software module and a result merger software module. The software modules can operate a service that is logically coupled to at least one search provider. The details of these and other aspects and embodiments of the disclosure are set forth in the accompanying drawings and the description below. Other features, objects, and advantages of the various embodiments will be apparent from the description and drawings, as well as from the claims.

### DESCRIPTION OF DRAWINGS

FIG. 1 illustrates an example business data processing system that implements a combined search for structured and unstructured data in accordance with one implementation of the present disclosure;

FIG. 2 illustrates an interrelation of various components utilized for a combined search in accordance with certain embodiments of the present disclosure;

FIG. 3 illustrates an interrelation of various components utilized for the combined search query provider in accordance with certain embodiments of the present disclosure;

FIG. 4 shows the rough architecture of the attachment search service;

FIG. 5 shows a schematic illustration of a repository-only search scenario according to one implementation of the present disclosure;

FIG. 6 shows a schematic illustration of a combined search scenario according to one implementation of the present disclosure;

FIG. 7 shows a schematic illustration of a combined search scenario according to one implementation of the present disclosure;

FIG. 8 shows a schematic illustration of an attachment-only search scenario according to one implementation of the present disclosure;

FIG. 9 shows a schematic illustration of a sorting method used when searching attachments according to one implementation of the present disclosure; and

FIG. 10 shows a sequence diagram that outlines how a search is executed and which components are involved according to one implementation of the present disclosure.

### DETAILED DESCRIPTION

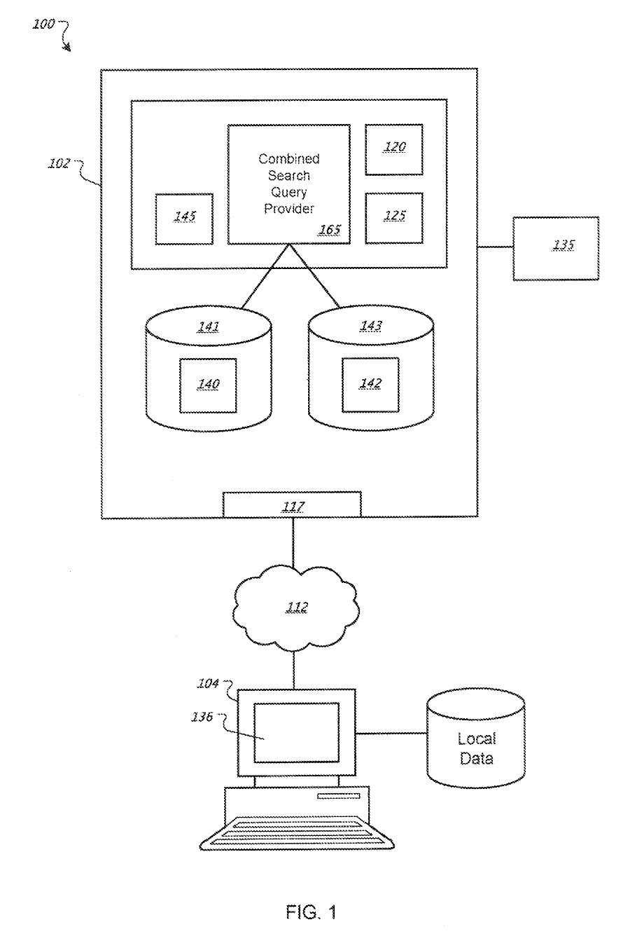

The present disclosure relates to methods, systems, and software for the combination of attachment searches and relatively fast searches to allow the user to search through unstructured and structured data, respectively. The search requester may also query attributes associated with such attachments. For example, the disclosure describes example components and techniques for intelligently parsing a query into sub-queries based on relevance and then intelligently combining the results beyond mere aggregation. Specifically, FIG. 1 illustrates an example business data processing system 100 that implements such concurrent search capability for structured and unstructured data in accordance with one implementation of the present disclosure. The system 100 includes a server 102 for managing data services, such as business objects (often termed BOs) 140 and unstructured data (such as attachments) 142. The server 102 can typically be accessed in a stand-alone fashion (such as a website), within any suitable productivity tool (whether enterprise software, email application, and others) selected by the user or automatically interfaced, or in a cooperative fashion with a third party search engine. In other words, system 100 may manage and share a knowledge base of software assets or other data services (often using metadata) that can easily be integrated into different developer and end user tools.

System 100 is typically a distributed client/server system that spans one or more networks such as 112. In such cases, the various components—such as servers 102 and clients 104—may communicate via a virtual private network (VPN), Secure Shell (SSH) tunnel, or other secure network connection. Accordingly, rather than being delivered as packaged software, system 100 may represent a hosted solution that may scale cost-effectively and help drive faster adoption. In this case, portions of the hosted solution may be developed by a first entity, while other components are developed by a second entity. In such embodiments, data may be communicated or stored in an encrypted format using any standard or proprietary encryption algorithm. This encrypted communication may be between the user (or application/client) and the host or amongst various components of the host. Put simply, communication or other transmission between any modules and/or components may include any encryption, export, translation or data massage, compression, and so forth as appropriate. Further, system 100 may store some data at a relatively central location, while concurrently maintaining local data at the user's site for redundancy and to allow processing during downtime. But system 100 may be in a dedicated enterprise environment—across a local area network (over LAN) or subnet—or any other suitable environment without departing from the scope of this disclosure.

Turning to the illustrated embodiment, system 100 includes or is communicably coupled (such as via a one-, bi-, or multi-directional link or network) with server 102 and one or more clients 104, at least some of which communicate across network 112. Server 102 comprises an electronic computing device operable to receive, transmit, process, and store data associated with system 100. Generally, FIG. 1 provides merely one example of computers that may be used with the disclosure. Each computer is generally intended to encompass any suitable processing device. For example, although FIG. 1 illustrates one server 102 that may be used with the disclosure, system 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers, as well as computers without conventional operating systems. Server 102 may be adapted to execute any operating system, including Linux, UNIX, Windows Server, or any other suitable operating system. According to one embodiment, server 102 may also include or be communicably coupled with a web server and/or a mail server.

Illustrated server 102 includes local memory 120 and may be coupled to a repository 135. Memory 120 and repository 135 may include any memory or database module and may take the form of volatile or non-volatile memory including, without limitation, magnetic media, optical media, random access memory (RAM), read-only memory (ROM), removable media, or any other suitable local or remote memory component. Illustrated memory 120 includes data services but may also include any other appropriate data such as VPN applications or services, firewall policies, a security or access log, print or other reporting files, HTML files or templates, data classes or object interfaces, child software applications or sub-systems, and others. Consequently, memory 120 and repository 135 may be considered a repository of data, such as a local data repository, for one or more applications.

For example, memory 120 may include, point to, reference, or otherwise store a business object repository. In some embodiments, the business object repository may be stored in one or more tables in a relational database described in terms of SQL statements or scripts. In the same or other embodiments, the business object repository may also be formatted, stored, or defined as various data structures in text files, eXtensible Markup Language (XML) documents, Virtual Storage Access Method (VSAM) files, flat files, Btrieve files, comma-separated-value (CSV) files, internal variables, or one or more libraries. In short, the business object repository may comprise one table or file or a plurality of tables or files stored on one computer or across a plurality of computers in any appropriate format. Indeed, some or all of the business object repository may be local or remote without departing from the scope of this disclosure and store any type of appropriate data. In particular embodiments, the business object repository may access the business objects in response to queries from clients 104.

These business objects 140 may represent organized data relating to some project or endeavor, which may or may not be linked, with each object having one or more states related to the object. Each of the states, in turn, is associated with data that pertains to various modifiable parameters of the individual states of the object. One type of data modeling that includes multiple objects, with each having multiple states and each state having multiple instances of changes to the state's modifiable parameters, is the business object model. Briefly, the overall structure of a business object model ensures the consistency of the interfaces that are derived from the business object model. The business object model defines the business-related concepts at a central location for a number of business transactions. In other words, it reflects the decisions made about modeling the business entities of the real world acting in business transactions across industries and business areas. The business object model is defined by the business objects 140 and their relationship to each other (the overall net structure).

Business object 140 is thus a capsule with an internal hierarchical structure, behavior offered by its operations, and integrity constraints. Business objects are generally semantically disjointed, i.e., the same business information is represented once. In some embodiments, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects 140 are generally arranged from the top to the bottom based on defined order of the business areas, e.g., finance could be arranged at the top of the business object model with CRM below finance and SRM below CRM. To ensure the consistency of interfaces, the business object model may be built using standardized data types as well as packages to group related elements together, and package templates and entity templates to specify the arrangement of packages and entities within the structure.

BO 140 is a representation of a business entity, such as an employee or a sales order. The BO 140 may encompass both functions (for example, in the form of methods) and data (such as one or more attributes) of the business entity. The implementation details of BO 140 are typically hidden from a non-development user, such as an end user, and the BO 140 may be accessed through defined functions. Accordingly, the BO may be considered encapsulated. BO may be used to reduce a system into smaller, disjunctive units. As a result, BOs can improve a system's structure while reducing system complexity. BOs also form a point of entry of the data and functions of a system and enable the system to easily share data, communicate, or otherwise operate with other systems. According to one implementation, BO 140 may include multiple layers.

Server 102 also includes processor 125. Processor 125 executes instructions and manipulates data to perform the operations of server 102 such as, for example, a central processing unit (CPU), a blade, an application specific integrated circuit (ASIC), or a field-programmable gate array (FPGA). Although FIG. 1 illustrates a single processor 125 in server 102, multiple processors 125 may be used according to particular needs, and reference to processor 125 is meant to include multiple processors 125 where applicable. In the illustrated embodiment, processor 125 executes or requests execution of at least one business application 145.

Other than BOs 140, system 100 may utilize various data services that can combine web services and data from multiple systems, in an application design made possible by a composite application framework. This framework typically includes the methodology, tools, and run-time environment to develop composite applications. It may provide a consistent object model and a rich user experience. Regardless of the particular type, category, or classification of the component, system 100 often stores metadata and other identifying information along with the actual piece of software (whether object or source). For example, the service may further include each component's definition, lifecycle history, dependents, dependencies, versions, use or “big name” cases, industry types or associations, role types, security profile, and usage information. More specifically, system 100 also includes (or otherwise references) unstructured data 142, generally described herein as attachments. Attachments 142 can include flat files, spreadsheets, graphical elements, design drawings, slide presentations, text documents, mail messages, or other files. In particular, if a combined search query is executed for business objects and attachments, the combined search query provider 165 can merge the result sets, such as lists of business objects matching the search query.

At a high level, business application 145 can be any application, program, module, process, or other software that may execute, change, delete, generate, or otherwise requests or implements batch processes according to the present disclosure. In certain cases, system 100 may implement a composite application 145. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET. Further, while illustrated as internal to server 102, one or more processes associated with application 145 may be stored, referenced, or executed remotely. For example, a portion of application 145 may be a web service that is remotely called, while another portion of application 145 may be an interface object bundled for processing at remote client 104. Moreover, application 145 may be a child or sub-module of another software module or enterprise application (not illustrated) without departing from the scope of this disclosure. Indeed, application 145 may be a hosted solution that allows multiple parties in different portions of the process to perform the respective processing. For example, client 104 may access application 145, once developed, on server 102 or even as a hosted application located over network 112, without departing from the scope of this disclosure. In another example, portions of software application 145 may be developed by the developer working directly at server 102, as well as remotely at client 104.

More specifically, business application 145 may be a composite application, or an application built on other applications, that includes an object access layer (OAL) and a service layer. In this example, application 145 may execute or provide a number of application services such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help composite application 145 to orchestrate a business process in synchronization with other existing processes (e.g., native processes of enterprise base systems) and leverage existing investments in the IT platform. Further, composite application 145 may run on a heterogeneous IT platform. In doing so, composite application 145 may be cross-functional in that it may drive business processes across different applications, technologies, and organizations. Accordingly, composite application 145 may drive end-to-end business processes across heterogeneous systems or sub-systems. Application 145 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes the composite application 145, it may instead be a standalone or (relatively) simple software program. Regardless, application 145 may also perform processing automatically, which may indicate that the appropriate processing is substantially performed by at least one component of system 100. It should be understood that this disclosure further contemplates any suitable administrator or other user interaction with application 145 or other components of system 100 without departing from its original scope. Finally, it will be understood that system 100 may utilize or be coupled with various instances of business applications 145. For example, client 104 may run a first business application 145 that is communicably coupled with a second business application 145. Each business application 145 may represent different solutions, versions, or modules available from one or a plurality of software providers or developed in-house. For example, business application 145 may include or be coupled with a combined search query provider 165. Various business applications 145 can use the combined search query provider 165, for example, to query business objects 140 (e.g., stored in a structured repository 141) and attachments 142 (e.g., stored in an unstructured repository 143). For instance, while searching the structured repository 141, the combined search query provider 165 can identify specific business objects 140 responsive to the query. Simultaneously, the combined search query provider 165 can search attachments 142 in the unstructured repository 143 for related information. This provider 165 could then intelligently Boolean the results such that appropriate items are presented, perhaps on a rolling basis, to avoid delays in response times.

Regardless of the particular implementation, “software” may include software and other computer implemental instructions, such as firmware, wired or programmed hardware, or any combination thereof, as appropriate. Indeed, each of the foregoing software applications may be written or described in any appropriate computer language including C, C++, Java, Visual Basic, assembler, Perl, any suitable version of 4GL, as well as others. It will be understood that while these applications are shown as a single multi-tasked module that implements the various features and functionality through various objects, methods, or other processes, each may instead be a distributed application with multiple sub-modules. Further, while illustrated as internal to server 102, one or more processes associated with these applications may be stored, referenced, or executed remotely. Moreover, each of these software applications may be a child or sub-module of another software module or enterprise application (not illustrated) without departing from the scope of this disclosure.

Server 102 may also include interface 117 for communicating with other computer systems, such as clients 104, over network 112 in a client-server or other distributed environment. In certain embodiments, server 102 receives data from internal or external senders through interface 117 for storage in memory 120, for storage in DB 135, and/or processing by processor 125. Generally, interface 117 comprises logic encoded in software and/or hardware in a suitable combination and operable to communicate with network 1 12. More specifically, interface 117 may comprise software supporting one or more communications protocols associated with communications network 112 or hardware operable to communicate physical signals.

Network 112 facilitates wireless or wireline communication between computer server 102 and any other local or remote computer, such as clients 104. Network 112 may be all or a portion of an enterprise or secured network. In another example, network 112 may be a VPN merely between server 102 and client 104 across wireline or wireless link. Such an example wireless link may be via 802.11a, 802.11b, 802.11g, 802.20, WiMax, and many others. While illustrated as a single or continuous network, network 112 may be logically divided into various sub-nets or virtual networks without departing from the scope of this disclosure, so long as at least portion of network 112 may facilitate communications between server 102 and at least one client 104. For example, server 102 may be communicably coupled to one or more “local” repositories through one sub-net while communicably coupled to a particular client 104 or “remote” repositories through another. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 112 may be a secure network associated with the enterprise and certain local or remote clients 104.

Client 104 is any computing device operable to connect or communicate with server 102 or network 112 using any communication link. For example, client 104 is intended to encompass a personal computer, touch screen terminal, workstation, network computer, kiosk, wireless data port, smart phone, personal data assistant (PDA), one or more processors within these or other devices, or any other suitable processing device. At a high level, each client 104 includes or executes at least one GUI 136 and comprises an electronic computing device operable to receive, transmit, process, and store any appropriate data associated with system 100. It will be understood that there may be any number of clients 104 communicably coupled to server 102. Further, “client 104,” “business,” “business analyst,” “end user,” and “user” may be used interchangeably as appropriate without departing from the scope of this disclosure. Moreover, for ease of illustration, each client 104 is described in terms of being used by one user. But this disclosure contemplates that many users may use one computer or that one user may use multiple computers. For example, client 104 may be a PDA operable to wirelessly connect with external or unsecured network. In another example, client 104 may comprise a laptop that includes an input device, such as a keypad, touch screen, mouse, or other device that can accept information, and an output device that conveys information associated with the operation of server 102 or clients 104, including digital data, visual information, or GUI 136. Both the input device and output device may include fixed or removable storage media such as a magnetic computer disk, CD-ROM, or other suitable media to both receive input from and provide output to users of clients 104 through the display, namely, the client portion of GUI or application interface 136.

GUI 136 comprises a graphical user interface operable to allow the user of client 104 to interface with at least a portion of system 100 for any suitable purpose, such as viewing application or other transaction data. Generally, GUI 136 provides the particular user with an efficient and user-friendly presentation of data provided by or communicated within system 100. For example, GUI 136 may present the user with the components and information that is relevant to their task, increase reuse of such components, and facilitate a sizable developer community around those components. GUI 136 may comprise a plurality of customizable frames or views having interactive fields, pull-down lists, and buttons operated by the user. For example, GUI 136 is operable to display certain data services in a user-friendly form based on the user context and the displayed data. In another example, GUI 136 is operable to display different levels and types of information involving data services based on the identified or supplied user role. GUI 136 may also present a plurality of portals or dashboards. For example, GUI 136 may display a portal that allows users to view, create, and manage historical and real-time reports including role-based reporting, and such. Of course, such reports may be in any appropriate output format including PDF, HTML, and printable text. Real-time dashboards often provide table and graph information on the current state of the data, which may be supplemented by data services. It should be understood that the term graphical user interface may be used in the singular or in the plural to describe one or more graphical user interfaces and each of the displays of a particular graphical user interface. Indeed, reference to GUI 136 may indicate a particular interface accessible via client 104, as appropriate, without departing from the scope of this disclosure. Therefore, GUI 136 contemplates any graphical user interface, such as a generic web browser or touchscreen, that processes information in system 100 and efficiently presents the results to the user. Server 102 can accept data from client 104 via the web browser (e.g., Microsoft Internet Explorer or Mozilla Firefox) and return the appropriate HTML or XML responses to the browser using network 1 12.

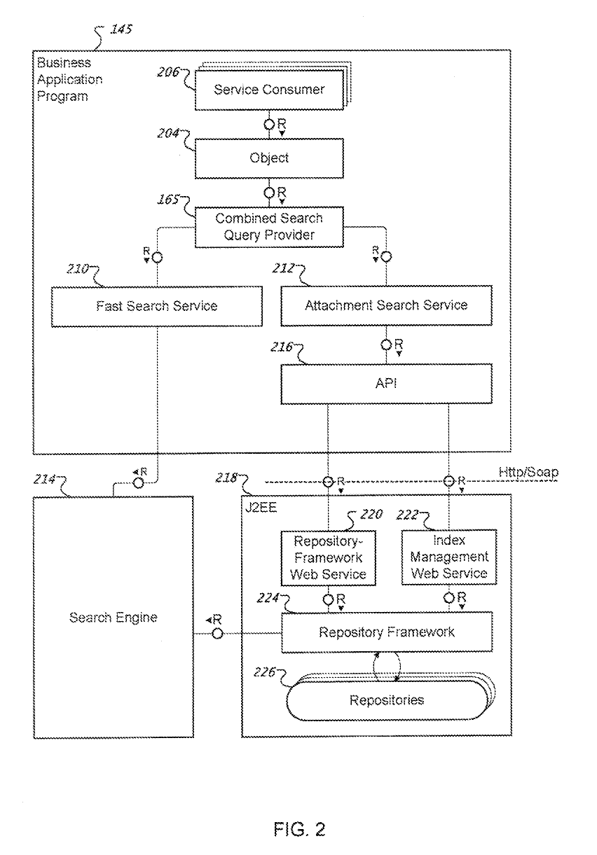

FIG. 2 illustrates an interrelation of various components utilized for a combined search in accordance with certain embodiments of the present disclosure. The combined search, in addition to allowing the user to search through structured data (e.g., business object node attributes), extends the search capabilities of queries to include attachments, such as attached documents. These attachments may, for example, belong to one or more specific business object nodes or may contain data related to one or more business objects. The search can be limited to a full text search of the attachment text or can include, in some implementations, attributes defined in the attachment.

For example, the illustrated architecture can allow a developer to define queries (or a user to utilize queries) within one or more business application programs 145 that use one or more business object nodes 204. In this way, the business application programs 145 can meet the combined search needs of service consumers 206. Specifically, the business application 145 may use combined search queries to access one or more business objects and related attachments or files. For example, a combined search query provider 165 can divide a combined search query into a fast search service 210 and an attachment search service 212.

The fast search service 210 can use a fast search infrastructure or other query provider to execute the query. In this scenario, the fast search service 210 can provide query input to a search engine 214. After executing the query, the search engine 214 can provide the search results responsive to the query to the fast search service 210. The search results can be in the form of a list of business object node IDs corresponding to the business objects matching the query. The returned business object node IDs typically can represent instances of the business object node to which the query is attached (e.g., an “anchor” business object node). If the query uses the fast search infrastructure to execute the query, a fast search query provider can be registered with the query. Because the fast search infrastructure can allow the definition of queries across different business object nodes, the input structure can be mapped to fields of an underlying fast search view.

The attachment search service 212 of the combined search can also be an extension of the fast search query provider 165. The attachment search service 212 can use an application programming interface (API) 216 as an interface to a J2EE 218 where the attachment query is handled. The example J2EE 218 includes a repository framework web service 220 and an index management web service 222. The repository framework web service 220 can provide the web services used for accessing a repository framework 224. For example, the repository framework 224 can include definitions of the types of attachments that can be searched. The index management web service 222 can provide web services used for managing the indexes associated with the repository framework 224. Such indexes, for example, can be used to improve the efficiency by which repositories 226 are searched. The J2EE 218 can use the search engine 214 to execute attachment-based queries. Of course, the foregoing components are for illustration purposes only and other components in different arrangements may be used to implement the techniques described herein. For example, the fast search service 210 might be connected to one instance of search engine 214, while attachment search service 212 (as well as 218) might be connected to a different instance of search engine 214. Indeed, the two instances of search engine 214 might be based on different technologies and might reside on different devices.

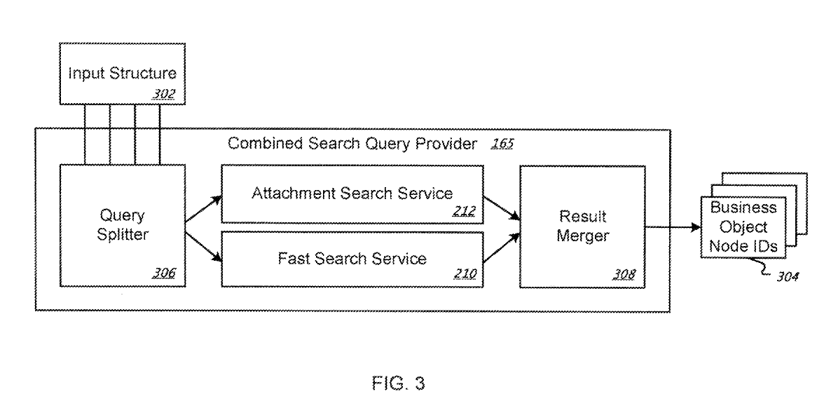

FIG. 3 illustrates an interrelation of various components utilized for the combined search query provider 165 in accordance with certain embodiments of the present disclosure. The combined search query provider 165 can receive an input structure 302, such as a query, and identify and provide business object node IDs 304 responsive to the query. In a specific example, the input structure 302 may be a combined query (i.e., searching objects and attachments) submitted by an organization's business application to identify purchase orders of 11-mm ball bearings from a specific vendor. In particular, the query may be directed at the business objects 140 stored in the organization's repository 141 (e.g., purchase order, vendor, and inventory data bases) and one or more attachments 142 stored in the organization's unstructured repository 143. For instance, the attachments can include flat files, spreadsheets, graphical elements, design drawings, slide presentations, text documents, mail messages, or other electronic files.

The query received by the search query provider 165 is first appropriately split up or otherwise parsed into parts. Depending on the search scenario, the query can be executed in either or both the fast search service 210 and the attachment search service 212. Determining where the query is executed is handled by a query splitter 306. The outputs of services 210 and 212 are merged into a single output list by a result merger 308. While the query splitter 306 and result merger 308 form the framework for combined search, the fast search service 210 and the attachment search service 212 handle the respective execution of the search.

For example, upon receipt of a combined query for purchase orders of 11-mm ball bearings from a specific vendor, the query splitter 306 can split the combined query into two components: a first query component targeting business objects 140 and a second query component targeting one or more attachments 142. The query splitter 306 can provide the first query component to the fast search service 210 and the second query component to the attachment search service 212. The services 210 and 212 can then perform their corresponding searches. In particular, the fast search service 210 can use a search engine (e.g., search engine 214) to identify business objects responsive to the query. The result can be a list of purchase orders matching the query. Similarly, the attachment search service 212 can search designated attachments for purchase order business objects matching the query. For example, if the query is for purchase orders for 11-mm ball bearings from a specific vendor, the attachment search service 212 can provide a list of the query-matching purchase orders found within the specified attachments; e.g. purchase orders that have an attached file that includes the term “11-mm” in the full text, metadata, and so forth. The list of purchase orders can be, for example, in the form of a list of business objects.

After the services 210 and 212 provide their search results, the result merger 308 merges the results into a merged results set, such as the business object node IDs 304. A number of steps are necessary by the result merger 308 to ensure that the result lists (list of business object node IDs) are sorted, paged and merged correctly. Particularly, depending on the query scenario, the merged list may rely on objects that appear on both lists (e.g., as specified by an “AND” operation) or on either list (e.g., as specified by an “OR” operation).

Table 1 below, Input Structure for Combined Search Query Provider, shows an example input structure for the combined search query provider 165. For example, the query splitter 306 can receive such structures as the input structure 302, such as in a query received from a business application. The structure serves to provide the rules for scenario selection and data passing to the combined search query provider 165.

| Name | Type | Description |
|---|---|---|
| SEARCH_ATTRIBUTE 1 | | FSI Attributes |
| . . . | | |
| SEARCH_ATTRIBUTE n | | |
| FSI_SEARCH_TEXT | FSI_SEARCH_TEXT_T | Phrase Search |
| | | Text |
| ATT_PHRASE_ATTR | STRING | Attachment |
| | | Attributes |
| SCENARIO | CS_SCENARIO_TYPE | Scenario Type |

The query input structure can include fields that may be used for the fast search service 210 and the attachment search service 212. Apart from fields that can be mapped to view fields, the structure includes a field (i.e., FSI_SEARCH_TEXT) which is used for the phrase search string. As shown, Table 1 defines an example field for searching attachments (i.e., ATT_PHRASE_ATTR), and a similar field or structure can also be used for fast searches (i.e., not using attachments) and combined searches (i.e., using attachment and fast search services).

The phrase search string (i.e., FSI_SEARCH_TEXT) can be reused in a combined search. It sets the phrase that can be sent to the attachment search service 212. Two other fields are defined that are specific to a combined search. A scenario flag (i.e., SCENARIO) can be used to define how the search results from the two searches (i.e., fast service and attachment service) are to be combined. The attachment attribute string can be used to pass the attachment attributes to the query splitter 306. In this way, the query splitter 306 can instruct the services 210 and 212 to create result sets that the result merger 308 can combine according to the designated scenario.

The attachment attributes (i.e., ATT_PHRASE_ATTR) and search string can all be included in one combined string or other structure. When doing so, the name value pairs can be separated by separation markers. For example, the following syntax can be used. The beginning of the string can hold the search phrase, followed by the attributes. The same syntax used for the attachment search service 210 can be used for the fast search service 212.

Consider a query such as:

“term1 AND term2 OR
(@{http://Asite.com/docs}DocType=Offer
and @{http://Asite.com/docs}Usage=All)”

In this example, the query would search for documents that contain the terms “term1” and “term2” in their content or that have the document property DocumentType=“Offer” and Usage=“All.” Moreover, the various document properties can belong to multiple namespaces. Accordingly, the above example Http://namespace is a limiting namespace for the attributes “DocumentType” and “Usage”, respectively, to further target the search.

Table 2 below, Scenarios Possible for Combined Search Query Provider, lists example scenarios that are possible using the combined search query provider 165. For example, a scenario type of “B” can be used when the attachment capability of the combined search is to be bypassed, such as when just a fast search is to be performed (e.g., using object repositories). Similarly, a scenario type of “T” can be used when no search string is provided for a fast search. In this scenario, search text may still be provided for searching attachments. Other scenario types, such as “O” and “A,” can define how result sets from a combined search are to be merged. For example, the “O” scenario can represent the “OR” case in which the result merger 308 includes entries in the merged business object node IDs 304 if they appear on either object list produced by services 210 and 212. The “A” scenario can represent the “AND” case in which the result merger 308 includes entries in the merged business object node IDs 304 only if they appear on the object lists produced by both servers 210 and 212.

| Scenario Type | Description |
|---|---|
| B (implicit) | Bypass Attachment Search (Fast Search Only): when |
| | attachment string is empty |
| A (can be | Phrase Search combined by AND: the parameter |
| selected | “Scenario = A” must be included in |
| explicitly) | ATT_PHRASE_ATTR using the same syntax as the |
| | attribute fields. |
| O (default) | Phrase Search combined by OR: Default when both |
| | ATT_PHRASE_ATTR and FSI_SEARCH_TEXT are |
| | set. |
| M | Mixed Search: this scenario can replace the default |
| | “OR” Search. For example, Mixed Search mode can be |
| | used when the search term consists of several phrases |
| | that are joined together by logical AND and ORs. The |
| | search then combines the attribute and attachment |
| | search results, as well as the results from the individual |
| | phrases. |
| T (implicit) | Attachment Search Only: used when no |
| | FSI_SEARCH_TEXT is given |

Table 3 below, Query Splitter and Result Manager, lists example methods that can be used by the combined search query provider 165. For example, one or more of the methods may be called or executed one or more times depending on the scenario. For example, in a scenario involving a query of business objects and non-structured attachments, methods such as callFastSearch and callAttachmentSearch may be used one or more times. Specifically, the method callFastSearch may be used to find matching business objects in the repository, while the callAttachmentSearch method may be used to search one or more attachments.

| Example Methods | Description |
|---|---|
| getViewNodes | Get nodes associated with the |
| | underlying view. For example, BO |
| | nodes that are included in the definition |
| | of the search query may be retrieved. |
| getAnchorNode | Retrieve the anchor node of the BON |
| | returned by attachment search. For |
| | example, if the search hit a BO node |
| | that is a subnode of a particular |
| | Business Object (e.g. a Sales Order |
| | Item), this call retrieves the root node |
| | (e.g. the Sales Order Header node) |
| callAttachmentSearch | Make a call to the attachment search |
| | service |
| callFastSearch | Make a fast search call |
| getResults | Get the results from a . . . b with operator A |
| sort | Sort the result set using a Fast Search |
| | call |

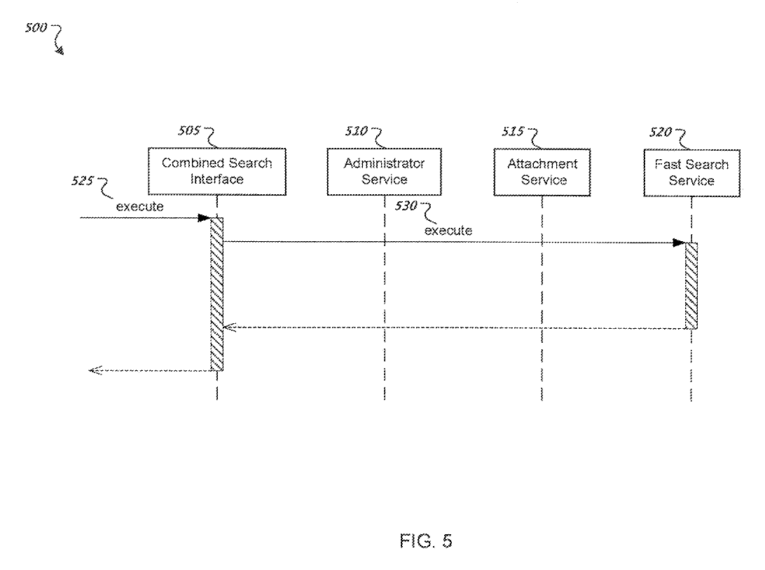

The particular methods executed (and the order in which they are executed) for a specific query can be determined by the query splitter 306 based on, for example, the Scenario Type parameter (e.g., refer to Table 2) passed with the input structure 302. These scenario-based behaviors are discussed below in reference to FIGS. 5-8.

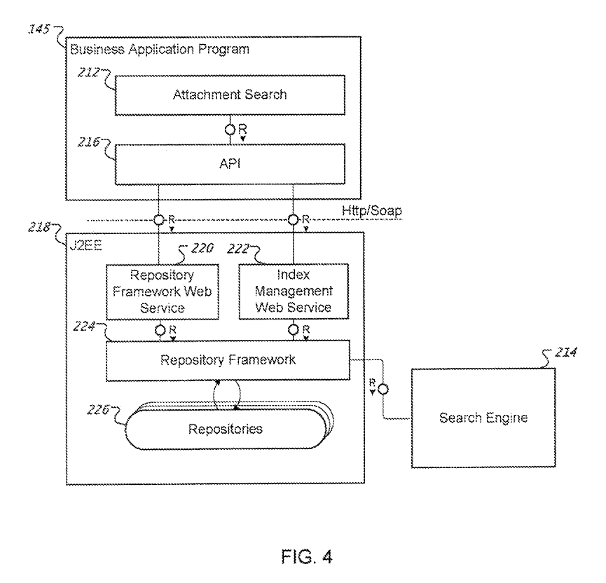

FIG. 4 shows the rough architecture of the attachment search service. Specifically, FIG. 4 depicts the interrelationships of the components from FIG. 2 that can be used for searching attachments. As described in reference to FIG. 2, searching attachments can be accomplished using the same search engine 214 as is used for fast searches of business object repositories or using different search engines 214 that are executed or requested concurrently. The attachment search service 212 provides the capability to search for business objects embedded in one or more attached documents. This search can be either a full text search over the attachments' content, a search via defined properties of documents, or a combination of both.

FIG. 5 shows a schematic illustration of a repository-only search scenario 500 according to one implementation of the present disclosure. Specifically, the repository-only search can be represented by the “Bypass” or “B” scenario code, signifying that attachment searching is being bypassed. In this scenario, the attachment search service 212 is not called. Instead, the query is simply passed to the fast search service 210. Since both the combined search query provider 165 and the fast search service 210 implement the same interface, the interface methods can simply be mapped to an instance of the fast search service 210. The result of the fast search call is thus passed as the result of the combined search call. The result merger 308 is not needed because the fast search service 210 can handle sorting and paging requirements. There is also no output from the attachment search service 212 to merge.

The schematic illustrated in FIG. 5 includes example interactions that can occur in various scenarios of combination searches, including various types of combination searches and “non-combination” searches that bypass either the fast search or the attachment search. Specifically, the schematic includes a combined search interface 505, an administrator service 510, an attachment service 515, and a fast search service 520. The combined search interface 505 can represent the interface to the combined search query provider 165. For example, referring to FIG. 3, queries received by the query splitter 306 via the input structure 302 can pass, in a logical sense, through the combined search interface 505. The administrator service 510 can provide administrative (i.e., non-search) services of the combined search query provider 165. In a sense, administrator service 510 can include capabilities that can be associated with the query splitter 306 and the result merger 308. The attachment service 515 can represent the capabilities of the attachment search service 212. The fast search service 520 can represent the capabilities of the fast search service 210.

In the “Bypass” search scenario, the search is initiated when the combined search interface 505 is executed at step 525. For example, the combined search query provider 165 may receive a query via the input structure 302 that is coded to use the “Bypass” scenario in which no attachments are to be searched. Specifically, the query may be designed to search only the structured data of object repositories. Because the query is for a “non-combination” search, the combined search interface 505 can immediately forward the query to the fast search service 520, passing the search attributes and the search phrase at step 530.

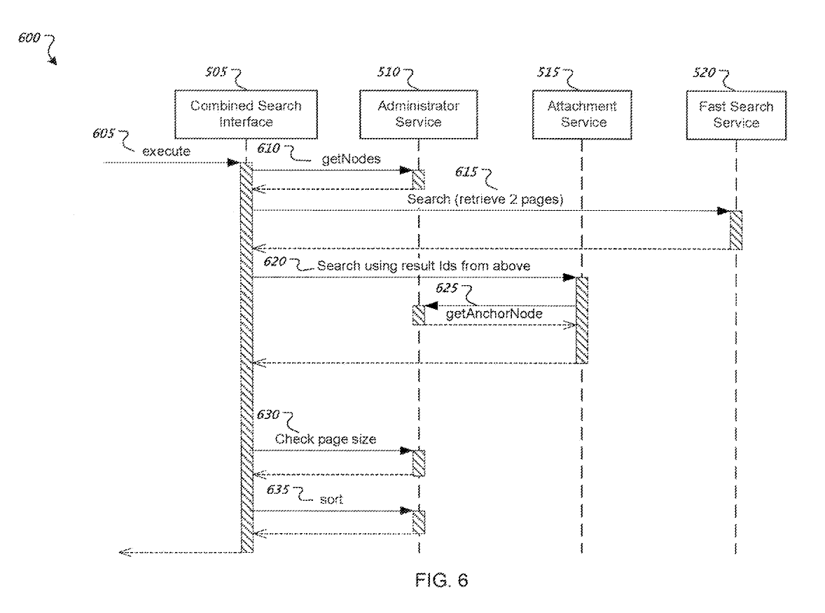

FIG. 6 shows a schematic illustration of a combined search scenario 600 according to one implementation of the present disclosure. Specifically, FIG. 6 depicts the “A” (or “AND”) scenario in which both the repository of business objects and one or more attachments are to be searched. In this scenario, the combined search query provider 165 returns results for entries for which the search phrase is matched in both structured and attachment data. The search parameters are passed to both the attachment search and to the fast search.

In the “AND” search scenario, the search is initiated when the combined search interface 505 is executed at step 605. For example, referring to FIG. 3, the combined search query provider 165 may receive a query via the input structure 302 which contains the search attributes (i.e., for both the attachment and fast search) and the search phrase. At step 610, the combined search interface 505 gets all nodes associated which the underlying view. The fast search occurs at step 615 when the combined search interface 505 invokes the fast search service 520. In this step, the fast search service 520 retrieves not only the BO node ID of the anchor node but also the IDs of all BO nodes in the associated view. At step 620, the combined search interface 505 invokes the attachment service 515 to search attachments for the search phrase. In order to improve performance, step 620 can be characterized by supplying only the node IDs that were produced by the fast search call as input to the attachment search service. At step 625, the attachment service 515 can invoke the administrator service 510 to get the anchor node associated with the BO node IDs before returning the search results to the combined search interface 505. At step 630, the page size can be checked. If at this point the page size is not yet filled, the above steps can be repeated until the page is filled. When the page is filled, the counter for the fast search call (e.g., last hits count number) can be saved. The next page request can then start at this point. At step 635, the result set of the combined search can be sorted.

In some implementations, search calls can be arranged such that efficiencies in paging can be realized. The fast search call is set to retrieve twice the amount of hits that are required by the execute call. Assuming that fast search and the attachment search provide roughly the same number of hits, it can be assumed that only a fraction of the fast search hits will also be returned by the attachment call. In case the final result does not contain enough hits to fill the page, the fast search call can be repeated, retrieving the next page.

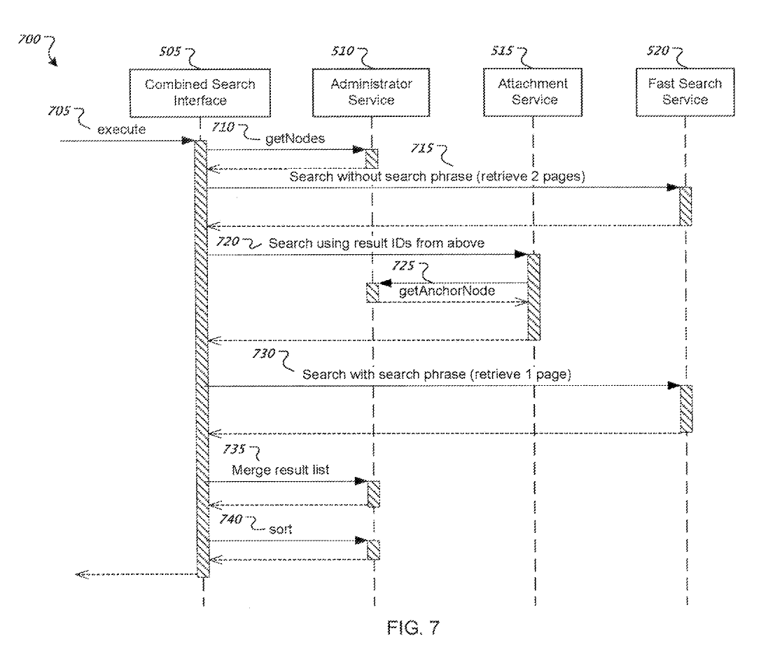

FIG. 7 shows a schematic illustration of a combined search scenario 700 according to one implementation of the present disclosure. Specifically, FIG. 7 depicts the “O” (or “OR”) scenario in which both the structured data and one or more attachments are searched. In this scenario, results are returned when the search phrase is present in either the structured data or the attachment data. The search parameters are passed to both the attachment search and to the fast search, and the results are merged.

In the “OR” search scenario, the search is initiated when the combined search interface 505 is executed at step 705. For example, referring to FIG. 3, the combined search query provider 165 may receive a query via the input structure 302 which contains the search attributes (i.e., for both the attachment and fast search) and the search phrase. At step 710, the combined search interface 505 gets all nodes associated which the underlying view. At step 715, the first fast search call retrieves the first page of possible hits when the combined search interface 505 invokes the fast search service 520. The number of hits typically can be a number greater than the final number because the search phrase is empty at this point. At step 720, the combined search interface 505 invokes the attachment service 515 to search attachments for the search phrase. In order to improve performance, step 720 can be characterized by supplying only the node IDs that were produced by the fast search call as input to the attachment search service. At step 725, the attachment service 515 can invoke the administrator service 510 to get the anchor node associated with the BO node IDs before returning the search results to the combined search interface 505. At step 730, the combined search interface 505 invokes the fast search service 520, passing the search phrase. The fast search service 520 can produce a list of BO node IDs responsive to the search phrase. If at this point the page size is not yet filled, the above steps can be repeated until the page is filled. When the page is filled, the counter for the fast search call (e.g., last hits count number) can be saved. The next page request can then start at this point. At step 735, the result lists from the two searches are merged. The merge can test each of the hits (i.e., potential positive matches) in the first fast search result list. If a particular hit is present in either the attachment search result list or the second fast search result list, the hit is appended to the final result list. At step 740, the merged result list of the combined search can be sorted.

In some implementations, a “mixed” scenario can be used. For example, if the user specifies more than one search phrase, the phrases can be joined by an “AND.” The entire phrase can then be passed to the attachment and fast search services. Result sets where part of the search phrase is included in a fast search attribute and the other part is found in the attachment search can be returned as a potential hit. Each potential hit representing a combination of sub-phrases can be examined, and the results combined.

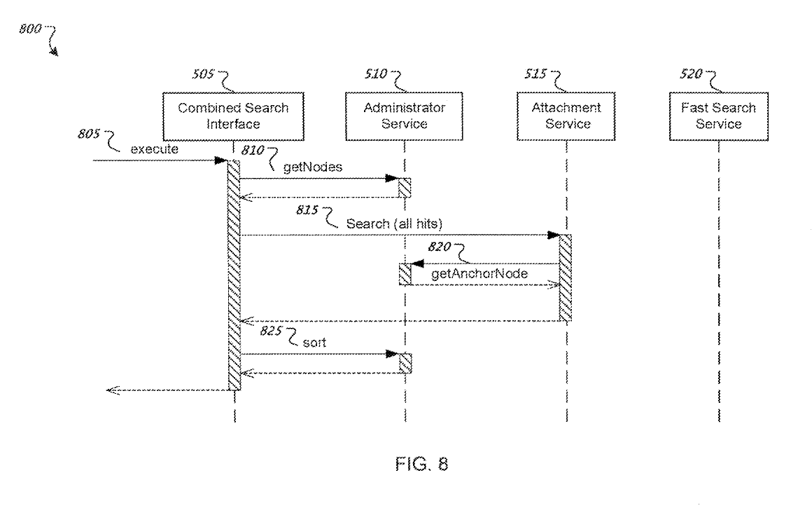

FIG. 8 shows a schematic illustration of an attachment-only search scenario 800 according to one implementation of the present disclosure. Specifically, the attachment-only search can be represented by the “T” scenario code, signifying that text searching is being bypassed. In this scenario, the attachment search service 212 is called, but the fast search service 210 is not called. The result merger 308 is not needed because the attachment search service 212 can handle call sorting and paging requirements. There is also no output from the fast search service 210 to merge.

In the attachment-only search scenario, the search is initiated when the combined search interface 505 is executed at step 805. For example, the combined search query provider 165 may receive a query via the input structure 302. Specifically, the query may be one coded to use the attachment-only “T” scenario in which no fast search is to be done. In particular, the query may be designed to search one or more attachments but not the structured data of BO repositories. At step 810, the combined search interface 505 gets all nodes associated which the underlying view. The attachment search occurs at step 815 when the combined search interface 505 invokes the attachment service 515. At step 820, the attachment service 515 can invoke the administrator service 510 to get the anchor node associated with the BO node IDs before returning the search results to the combined search interface 505. At step 825, the result set of the search can be sorted.

Sorting can occur when the result merger 308 is called to merge the result lists produced by the fast search service 210 and the attachment search service 212. The getResults method can import a table of attachment hits and a table of fast search hits. The attachment hits first can be mapped to the anchor node of the fast search view. Then, the two tables can be combined according to the Boolean operator (e.g., “AND” or “OR”). The combination of the two tables can eliminate all duplicates. In a next step, the resulting tables can be sorted according to the fast search sorting criterion. This can be done by calling fast search without a search phrase and comparing the result with the entries of the table to be sorted. Finally, the requested page size is calculated and the result table is modified accordingly.

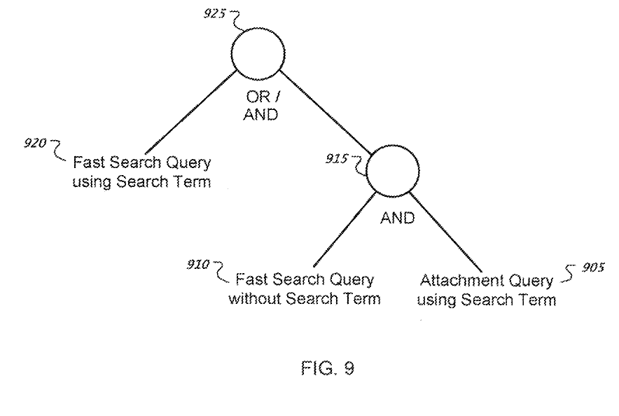

FIG. 9 shows a schematic illustration of a sorting method used when searching attachments according to one implementation of the present disclosure. After an attachment query using a search term 925 has been passed to the attachment search service at 905, the result list can be sorted according to the sorting criteria of the fast search call 910 perhaps using sorting criteria specified by the user and without a search term. The fast search query is used in this case to quickly sort the attachment results. The fast search results are looped and compared to the attachment result set. Those results that are part of the attachment result set 915 are kept for the next step. The results 920 from the fast search query (with the search term and the user-specified sorting criteria) are merged with the result list 915 from the first step. The merging depends on the Boolean operator defined by the search scenario (i.e., “AND” or “OR”). In the “AND” case, only results from both lists are included in the final result set 925. In the “OR” case, both sets are combined. In some implementations, sorting can be handled by an empty fast search call.

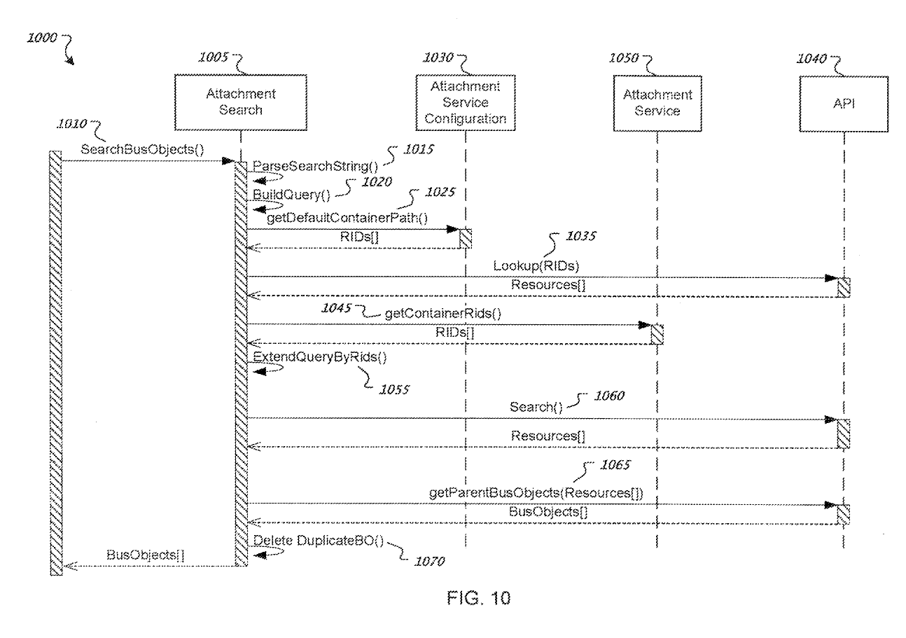

FIG. 10 shows a sequence diagram 1000 that outlines how a search is executed and which components are involved according to one implementation of the present disclosure. The attachment search 1005 receives the query, such as via a SearchBusObjects method call 1010. The attachment search 1005 parses the search string (e.g., by using a ParseSearchString method call 1015) and creates the query entries 1020 which are needed for the API. The attachment search 1005 also reads the default container path 1025 from the attachment service configuration 1030. If no BO is defined, all possible container paths can be considered. The attachment search 1005 instantiates a resource for each possible container path (e.g., via a Lookup (RIDs) method call to the API 1040). If a list of BOs is passed to the attachment search 1005, the corresponding resource IDs 1045 of the particular attachment container are read from the attachment service 1050 (e.g., using a relational table). These resource IDs can be added (1055) as properties to the query. With this, the query can be restricted to all documents having resource IDs starting with the resource ID of the attachment container. The attachment search 1005 executes the search 1060 and obtains a list of resources via the API 1040. The attachment search 1005 gets the BO of each resource via the API 1040, such as by using a getParentBusObjects method call. The attached document does not have any information about the BO to which it is attached. In some cases, the attachment container has this information, which may be stored as properties at the attachment container. Such attachment containers may be considered a folder (or other node or data structure) in a document management system that is the parent folder (or node or data structure) of documents attached to the particular business object ID. To get this information about the attached BO, the corresponding attachment container can be retrieved to get its properties. The path of the corresponding attachment container can be calculated from the resource ID of the found resource, as it is typically a hierarchical folder structure like “ . . . /container1/node2/attachment.txt.” Afterwards, a mass lookup for all attachment container resource IDs can be executed. Once the BOs are retuned via the API 1040, the attachment search 1005 deletes (1070) duplicate BOs and provides a list of BO node IDs.

Table 4 below, Identifying a Business Object Node, identifies fields in a Business Object Node according to one implementation of the present disclosure. Specifically, a BO node can be identified by a combination of a BO name (e.g., purchase order, sales order, etc.), a BO node name, and a BO node ID.

| Fieldname | Description |
|---|---|
| BO_NAME | Business Object Name |
| BO_NODE_NAME | Business Object Node Name |
| BO_NODE_ID | Business Object Node ID |

Table 5 below, Definition for Property Based Search, identifies fields in a structure that can be used to specify how properties in attachments are searched. For example, combined searches, in addition to being operable to search the contents of attachments, can also search based on the attributes or properties of an attachment, such as the metadata associated with the attachment. In particular, the metadata can include numerical, textual, language-based, or other types of attributes of a particular attachment. For example, one attribute of an attachment can be the file name that may contain the name of a specific business object.

| Fieldname | Data Element/Data Type | Description |
|---|---|---|
| NAMESPACE | STRING | Namespace of the |
| | | property |
| NAME | STRING | Property name |
| VALUE | STRING | Property Value |
| DATA_TYPE | /DOC/AS_SEARCH_PROP_TYPE | Data Type of the |
| | | property |
| PROPERTY_OPERATOR | /DOC/AS_SEARCH_PROP_OPERATOR | Property Operator |
| OPERATOR_TYPE | /DOC/AS_SEARCH_OPERATOR_TYPE | Type of the operator |
| | | (if value defines an |
| | | operator) |
| ACTION | /DOC/AS_SEARCH_ACTION | How to execute the |
| | | Search |

A particular property defined by the structure of Table 5 can have a specific namespace. Namespaces for properties may be defined according to a predefined syntax, such as a custom namespace table maintained on a web portal (e.g., http://XYZ123.com/˜/custom). A property can also have a property name, such as a file type or a file source, and a property value. For example, a property type such as “file type” may have a property value such as “email” or “spreadsheet.” Each property value can have a particular data type, which may be represented by an integer (e.g., 2=Date, 3=Integer, 5=String, etc.). A property operator field can describe possible ways for properties to be compared, and may be represented by integers (e.g., 0=Not Null, 1=Equal, 2=Not equal, 3=Between, 4=Greater, 5=Greater equal, 6=Less, 7=Less equal, etc.). An operator type can describe the type of property operator and can be represented by integers (e.g., 1=Operator (And/Or), 4=Open Bracket, 5=Closed Bracket, etc.). An action field (e.g., 1=Exact, 2=Fuzzy, 3=Linguistic) can identify the extent by which a property value can match a query. For example, an “exact” action may be used for an integer comparison. A “fuzzy” action, for example, may specify that one or more properties are to match closely (e.g., 80%) but not necessarily perfectly, or that as many as possible properties are to match. A “linguistic” action may, for example, allow matching by words or phrases that sound alike or are spelled similarly.

Beyond the examples in FIGS. 5-8 and 10, the search software may be operable to execute or implement other methods or techniques. For example, a SearchBusObjects method can search for documents which are connected to a specific business object. As a result, it can deliver a list of BO node keys. Import parameters of the SearchBusObjects method can include a specialized search string that can be used as a full text search and property search. The search string can contain, for example, search terms, operators, and brackets to help form logical expressions. Individual terms can be separated, for example, by spaces. Terms that themselves contain one or more embedded spaces can be surrounded by double quotes or other predefined delimiters. Search terms without any operator between them can be combined by an “AND.” Properties can have the convention of having a leading @ and may be defined according to the following syntax: “@{Namespace}/PropertyName” (e.g., “@{http://XYZ123/˜}/DocumentType=Offer”). Another import parameter (e.g., IT_BUS_OBJECTS) can define a list of business object nodes to which a particular search is to be restricted. The restriction can also be made to a BO name or a combination of a BO name and a BO node name. Then, the associated query is only executed for the given BOs and/or BO nodes. Export parameters of the method can include a list of BO node keys that match the search criteria. Any of these types of parameters and conventions can extend to various components of the combined search query provider 165.

Although this disclosure has been described in terms of certain embodiments and generally associated methods, alterations and permutations of these embodiments and methods will be apparent to those skilled in the art. For example, system 100 may include repository filters. With such filters, it can be possible to determine a property at run time directly in the repository framework. For example, if an attached document is accessed, such as during a search, the properties that contain information about the associated business object can be read from the corresponding attachment container. Specifically, the information can be available directly in the repository framework, such as in the J2EE 218, and can be visible at the resource itself. Such accessibility of information can improve performance of system 100. The combined search query provider 165 may use states in certain cases. For example, paging can be handled by states of the backend search engines (e.g., fast search). The state may be used only to save the current position in the fast search. This is not identical to the page the user is requesting. In some implementations, to help enable efficient calls to the attachment search service, the combined search can require an additional feature from the fast search infrastructure. For instance, the fast search call may not only retrieve the anchor business object node ID but also retrieve the business object node IDs of the nodes included in the fast search view. As this information is available with the fast search infrastructure, it can simply be passed via the API. A naming convention can be used to identify the BO nodes, as these are not necessarily view fields of the fast search view. Accordingly, the above description of example embodiments does not define or constrain this disclosure. Other changes, substitutions, and alterations are also possible without departing from the spirit and scope of this disclosure.

What is claimed is:

1. Software for querying heterogeneous business data, the software comprising computer readable instructions embodied on media and operable when executed to:
receive a query for heterogeneous business data, the business data comprising structured data and unstructured data stored across a plurality of repositories;
automatically parse the received query into sub-queries, each sub-query associated with either the structured or the unstructured data and one of the repositories and at least one of the sub-queries consisting of a portion of the received query; and
automatically merge results of the various sub-queries using business logic.

2. The software of claim 1, the plurality of repositories comprising a first structured repository and a first unstructured repository.

3. The software of claim 2 further operable to identify further results in the first structured repository based on results from the first unstructured repository.

4. The software of claim 2, the first structured repository storing a plurality of business objects, each business object associated with one or more nodes.

5. The software of claim 4, the first unstructured repository storing a plurality of attachments, each of at least a subset of the attachments associated with a business object node.

6. The software of claim 2 further operable to search the first unstructured repository based on a textual search of the unstructured data.

7. The software of claim 2 further operable to search the first unstructured repository based on an attribute search of the unstructured data.

8. The software of claim 1, wherein the software operable to automatically parse the received query into sub-queries comprises software operable to:
generate a first sub-query for structured data based on a subset of the query elements and business logic; and
generate a second sub-query for unstructured data based on a second subset of query elements and the business logic.

9. The software of claim 1, wherein the software operable to automatically merge the results comprises the software further operable to execute a union operation on the results.

10. The software of claim 1, wherein the software operable to automatically merge the results comprises software operable to execute an intersection operation of the results.

11. The software of claim 1 further operable to communicate the merged results on a rolling basis.

12. The software of claim 1, the software comprising at least two modules, the first module comprising a query splitter module and the second module comprising a result merger module.

13. The software of claim 12, the software operating as a service that is logically coupled to at least one search provider.

14. The software of claim 1, wherein the software operable to automatically merge the results comprises software operable to:
execute a query, with sorting criteria and independent of the query elements, on the structured data;
determine a union of the fast search and the results of the particular sub-query associated with the unstructured data; and
merge results of the union and the results of at least one sub-query associated with the structured data.

15. A computer implemented method for search structured and unstructured data comprising:
receiving a query for heterogeneous business data, the business data comprising structured data and unstructured data stored across a plurality of repositories;
automatically parsing the received query into sub-queries, each sub-query associated with either the structured or the unstructured data and one of the repositories and at least one of the sub-queries consisting of a portion of the received query; and
automatically merging results of the various sub-queries using business logic.

16. The method of claim 15, the plurality of repositories comprising a first structured repository and a first unstructured repository.

17. The method of claim 15, wherein automatically parsing the received query into sub-queries comprises:
generating a first sub-query for structured data based on a subset of the query elements and business logic; and
generating a second sub-query for unstructured data based on a second subset of query elements and the business logic.

18. The method of claim 15, wherein automatically merging the results comprises:
executing a query, with sorting criteria and independent of the query elements, on results obtained from at least one sub-query associated with the unstructured data;
determining a union of the fast search and the results of the particular sub-query associated with the unstructured data; and
merging results of the union and the results of at least one sub-query associated with the structured data.
